(19) United States
(12) Patent Application Publication
(10) Pub. No.: US 2004/0200309 A1
(43) Pub. Date: Oct. 14, 2004

(54) Accelerator device

(75) Inventors: Shigeru Hasegawa, Nagoya-city (JP); Hiroshi Takeyama, Obu-city (JP); Masahiro Makino, Kariya-city (JP); Hitoshi Amano, Okazaki-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/816,930

(22) Filed: Apr. 5, 2004

(30) Foreign Application Priority Data
Apr. 11, 2003 (JP) 2003-107772

(51) Int. Cl. F16H 59/20

(52) U.S. Cl. 74/513

(57) ABSTRACT

An accelerator device includes a bearing portion, an accelerator pedal having a cam with a cam shaft that is supported by the bearing portion to be turned forward and reversely by an action of a treading force, a follower that abuts against a cam surface of the cam when a turning position of the accelerator pedal is in a kickdown region, a bias device that generates a biasing force to press the follower against the cam surface, and a turning position sensor that detects a turning position of the accelerator pedal. Further, the biasing force of the bias device is set to act on the follower substantially toward a center of the cam shaft. Thus, the accelerator device can accurately detects a turning position of an accelerator pedal while giving a kickdown feeling to a driver.

### CROSS REFERENCE TO RELATED APPLICATION

This application is based on Japanese Patent Application No. 2003-107772 filed on Apr. 11, 2003, the disclosure of which is incorporated herein by reference.

### FIELD OF THE INVENTION

The present invention relates to a vehicle accelerator device in which a kickdown feeling is given to a driver when a pedal turning position of an accelerator pedal gets into a kickdown region.

### BACKGROUND OF THE INVENTION

As a kind of accelerator devices that control an operating state of a vehicle according to a tread operation of an accelerator pedal, there has been conventionally known a bywire type-accelerator device. In the bywire type accelerator device, an accelerator pedal is not connected mechanically to a throttle device of the vehicle. Further, a turning position sensor is used to detect a turning position of the accelerator pedal, and a detection value of the turning position sensor is output to a control unit for the throttle device.

In a vehicle provided with an automatic transmission, the number of speeds is forcedly lowered in kickdown when an accelerator pedal is fully trodden on and an engine load is increased. EP 0748713A discloses an accelerator device, in which a kickdown feeling is given to a driver when a turning position of an accelerator pedal gets into a kickdown region, in which kickdown is realized. Specifically, when a turning position of an accelerator pedal gets into the kickdown region, a projection rotatable together with the accelerator pedal spreads apart legs of a leaf spring having a U-shaped cross section via two rollers. Because it is required that a tread force increased by an amount, over which the leaf spring is spread apart, is exerted on an accelerator pedal, a driver can become aware of the fact that the turning position of an accelerator pedal gets into the kickdown region, on the basis of a change in a necessary tread force.

In this accelerator device, however, the leaf spring applies biasing forces in two directions on the projection. Therefore, the biasing forces are varied in the two directions in magnitude as the leaf spring is spread apart. A force acting on the shaft of the accelerator pedal may be reversed in direction since the biasing forces in the two directions that act on the projection are varied in magnitude. Since a clearance is provided between the shaft of the accelerator pedal and a bearing portion that supports the shaft, an offset direction is varied according to a direction of the force that acts on the shaft of the accelerator pedal. Therefore, when such structure is used for the bywire type accelerator devices, linearity of sensor output with respect to a tread stroke of the accelerator pedal greatly gets out of order in a case where offset is reversed in direction, so that detection accuracy of a turning position sensor is degraded.

### SUMMARY OF THE INVENTION

In view of the above-described problems, it is an object of the invention to provide an accelerator device that accurately detects a turning position of an accelerator pedal while giving a kickdown feeling to a driver.

According to the present invention, an accelerator device includes a housing having a bearing portion, an accelerator pedal having a cam with a cam shaft that is supported by the bearing portion to be turned forward and reversely by an action of a treading force, a follower that abuts against a cam surface of the cam when a turning position of the accelerator pedal is in a kickdown region, a bias device that generates a biasing force to press the follower against the cam surface, and a turning position sensor that detects a turning position of the accelerator pedal. Thus, a tread force required for causing the cam, having the cam surface pressed to the follower, to rotate when the pedal turning position gets into the kickdown region is varied according to the pedal turning position. Accordingly, a driver can become aware of the fact that the pedal turning position gets into the kickdown region, on the basis of a change in a necessary tread force. That is, it is possible to give a kickdown feeling to the driver.

Further, the bias device is disposed such that the biasing force acts on the follower substantially toward a center of the cam shaft. Therefore, an offset direction of the cam shaft can be maintained substantially constant when the pedal rotation position is in the kickdown region.

Preferably, an angle between a vector representative of a first force and a vector representative of a second force is an acute angle, when the first force is defined by a force applied from the follower to the cam while the turning position of the accelerator pedal is in the kickdown region, and when the second force is defined by a force that acts on the accelerator pedal while the turning position of the accelerator pedal is in the kickdown region and is a resultant force of forces except the first force. Accordingly, a direction, in which the cam shaft is made offset in the kickdown region, is not reversed relative to a direction of offset in a region except for the kickdown region, such as a fully closed position and in a normal region. In this case, the rotation position of the accelerator pedal can be accurately detected.

More preferably, the cam surface has a cam mountain portion to define a mountain-shaped profile curve in an axis-transverse cross section that is perpendicular to the cam shaft. In this case, when the accelerator pedal turns in a normal rotation direction as the treading force increases, the cam mountain portion abuts against the follower from rearward in the normal rotation direction to push the follower against the biasing force and thereafter separates from the follower. Further, a guide member can be provided for abutting against the follower from forward in the normal rotation direction to guide the follower in a predetermined direction. In this case, in the axis-transverse cross section, a tangent at a point, in which the cam mountain portion and the follower abut against each other, and a tangent at a point, in which the guide member and the follower abut against each other, intersect each other, and the biasing force acts on the follower toward the point of intersection.

In addition, the follower having an outer peripheral surface that is circular in cross section brings the cam mountain portion and the guide member into sliding contact with the outer peripheral surface of the follower while rotating about a center of the outer peripheral surface of the follower. Therefore, a wear of the follower, the cam and the guide member can be effectively restricted.

### BRIEF DESCRIPTION OF THE DRAWINGS

Other objects, features and advantages of the present invention will become more apparent from the following detailed description made with reference to the accompanying drawings, in which:

FIG. 1 is a schematic diagram showing forces applied to an accelerator pedal in an operation state of an accelerator device, according to a first embodiment of the present invention;

FIG. 2 is a cross-sectional view showing an operation state of the accelerator device, according to the first embodiment;

FIG. 3 is a partially-sectional plan view showing the accelerator device according to the first embodiment;

FIG. 4 is an enlarged sectional view showing a main part of the accelerator device in FIG. 2, according to the first embodiment;

FIG. 5 is a cross-sectional view taken along line IV—IV in FIG. 4;

FIG. 6A is a cross-sectional view showing the accelerator device when a pedal turning position of the accelerator pedal is at a kickdown starting position according to the first embodiment, and FIG. 6B is a schematically enlarged view showing a part of the accelerator device in FIG. 6A;

FIG. 7 is a schematically enlarged view showing the accelerator device when a treading force increases further after a follower roller begins to move, according to the first embodiment;

FIG. 8A is a cross-sectional view showing the accelerator device when the treading force further increases from the position of FIG. 7 according to the first embodiment, and FIG. 8B is a schematically enlarged view showing a part of the accelerator device in FIG. 8A;

FIG. 9 is a cross-sectional view showing the accelerator device when the pedal turning position is in a normal region, according to the first embodiment;

FIG. 10 is a graph for explaining operation of the accelerator device according to the first embodiment;

FIG. 11 is a schematic diagram showing forces applied to the accelerator pedal when the pedal turning position is at a fully closed position in the accelerator device, according to the first embodiment;

FIG. 12 is a schematic diagram showing forces applied to the accelerator pedal when the pedal turning position is in the normal region in the accelerator device, according to the first embodiment;

FIG. 13 is a schematic diagram showing forces applied to the accelerator pedal when the pedal turning position is in the kickdown region in the accelerator device, according to the first embodiment;

FIGS. 14A, 14B and 14C are a cross-sectional view, a side view and a bottom view, respectively, showing a bias device of an accelerator device according to a second embodiment of the present invention;

FIGS. 15A, 15B and 15C are a cross-sectional view, a side view and a bottom view, respectively, showing a bias device of an accelerator device according to a third embodiment of the present invention; and

FIGS. 16A, 16B and 16C are a cross-sectional view, a side view and a bottom view, respectively, showing a bias device of an accelerator device according to a fourth embodiment of the present invention.

### DETAILED DESCRIPTION OF THE PREFERRED EMBODIMENTS

(First Embodiment)

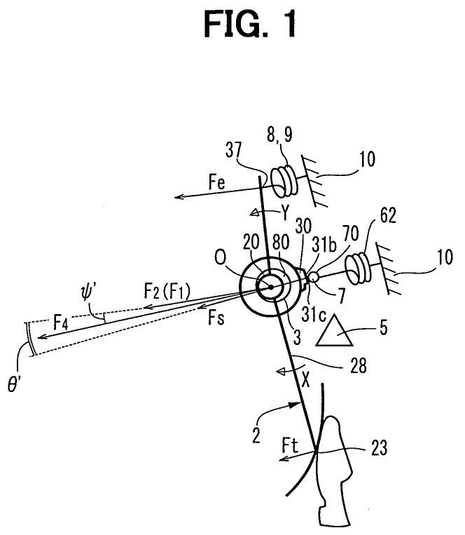

The first embodiment of the present invention will be now described with reference to FIGS. 1-13. An accelerator device 1 according to the first embodiment is mounted on a vehicle provided with an automatic transmission that realizes kickdown, and controls a vehicle operating state according to a treading operation of an accelerator pedal 2 by a driver. The accelerator device 1 adopts an accelerator bywire system, and the accelerator pedal 2 is not connected mechanically to a throttle device of the vehicle. In contrast, the accelerator device 1 enables a turning position of the accelerator pedal 2 detected by a turning position sensor 4 to be transmitted to an engine control unit (ECU) of the vehicle, and the ECU controls the throttle device on the basis of a transmitted turning position.

The accelerator pedal 2 in the accelerator device 1 has a rotating shaft 20 supported on a bearing portion 3 that is formed on a housing 10 as a support member, and is reversely turned around an axis O of the rotating shaft 20. The housing 10 is formed from a resin material to be box-shaped with an opening 10a, and includes a bottom plate 11, a roof plate 12, side plates 13, 14, and a connection plate 15.

The bottom plate 11 is fixed to the vehicle by means of bolts, etc. The roof plate 12 opposed to the bottom plate 11 is provided integrally with a pedal stopper 5. Further, a support hole 16 in the form of a rectangular-shaped hole and an engagement hole 17 in the form of a stepped cylindrical-shaped hole are provided on an inner wall of the roof plate 12. The support hole 16 receives therein a bias device 6 and a follower roller 7. The side plates 13, 14 are connected vertically to the bottom plate 11 and the roof plate 12 to be opposed to each other. One side plate 13 can be mounted to and dismounted from a portion of the housing 10. That is, the side plate 13 is disposed to be detachably attached to the housing 10. The side plate 13 is formed integrally on an inner wall thereof with a cylindrical-shaped bearing 3. The turning position sensor 4 arranged on an inner-peripheral side of the bearing portion 3 is supported by a portion of the side plate 13, which closes a base-end side of the bearing portion 3. Provided integrally on an outer wall of the side plate 13 is a connector 19, in which terminals 18 electrically connected to the turning position sensor 4 is embedded. The connection plate 15 is arranged to connect between one end of the bottom plate 11 and one end of the roof plate 12 and between respective one ends of the side plates 13, 14. The opening 10a of the housing 10 is formed between the other end of the bottom plate 11 and the other end of the roof plate 12 and between respective other ends of the side plates 13, 14.

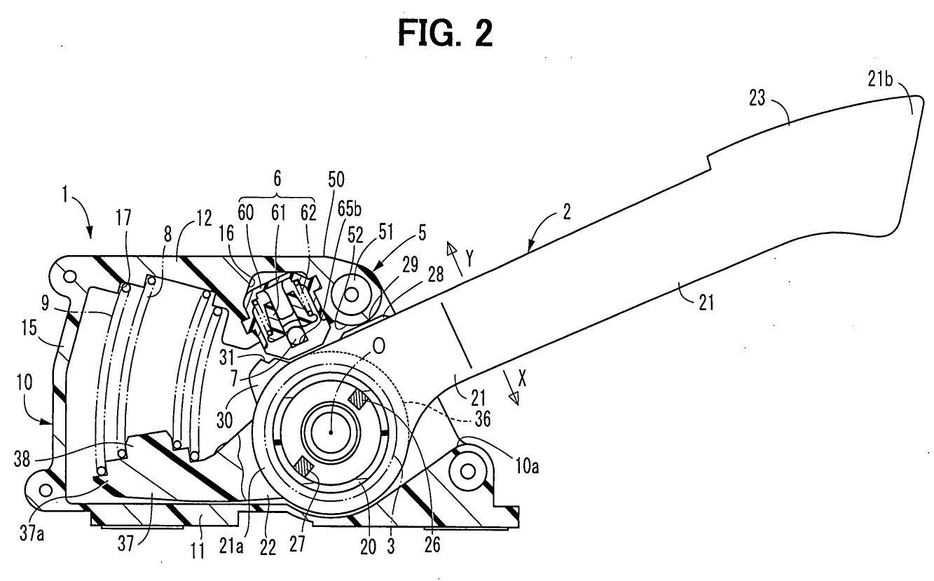

The accelerator pedal 2 includes an arm 21 and a rotor 22. The arm 21 formed from a resin material extends from one end 21a having the rotating shaft 20 to the other end 21b that projects outside the housing 10 from the opening 10a. The arm 21 includes a tread portion 23 on the other end 21b that projects outside the housing 10. When a driver operatively treads on the tread portion 23 from above in FIG. 2, a treading force Ft is applied to the tread portion 23 in a direction X of normal rotation.

The arm 21 includes two side walls 24, 25 on a side of the end 21a received in the housing 10. The side walls 24, 25 are opposed to each other in parallel in a direction along the axis. The side wall 25 confronting the side plate 13 is provided integrally with the rotating shaft 20. The rotating shaft 20 projects from a wall surface of the side wall 25 toward the side plate 13 in the axial direction in a cylindrical shape. The rotating shaft 20 is inserted into an inner-peripheral side of the bearing portion 3 on the side plate 13 to be supported (born) by the bearing portion 3 to be reversely rotatable. Since the rotating shaft 20 is supported by the bearing portion 3, the arm 21 is made to be able to turn about the axis O in the direction X of normal rotation and in a direction Y of reverse rotation. When a driver treads on the tread portion 23, the arm 21 turns in the direction X of normal rotation. In the embodiment, a clearance for generating a shaft shift in a diametrical direction (radial direction) is provided between an outer peripheral surface of the rotating shaft 20 and an inner peripheral surface of the bearing portion 3, and the rotating shaft 20 is allowed to be radially displaced in the range of such clearance.

Magnets 26, 27 are embedded in the rotating shaft 20 to be disposed at two circumferential locations with the axis O therebetween and to be integrally rotatable. A magnetic field formed by the two magnets 26, 27 varies according to a rotating position of the rotating shaft 20. The turning position sensor 4 supported on the side plate 13 includes a Hall element or a magnetoresistive element or the like to detect the magnetic field formed by the magnets 26, 27. The magnets 25, 26 are arranged on an outer peripheral side of the turning position sensor 4 with a gap therebetween, in a state of non-contact with the rotating shaft 20. The turning position sensor 4 outputs a detection signal to the ECU electrically connected to the terminals 18. A detection signal output from the turning position sensor 4 represents a turning position of the rotating shaft 20.

The arm 21 includes a latch portion 28 (engagement portion) disposed between the rotating shaft 20 and the tread portion 23 in an extension direction of the arm 21. The latch portion 28 projects from a body of the arm 21 in the direction Y of reverse rotation. A projecting-side end surface 29 of the latch portion 28 is formed to be flat.

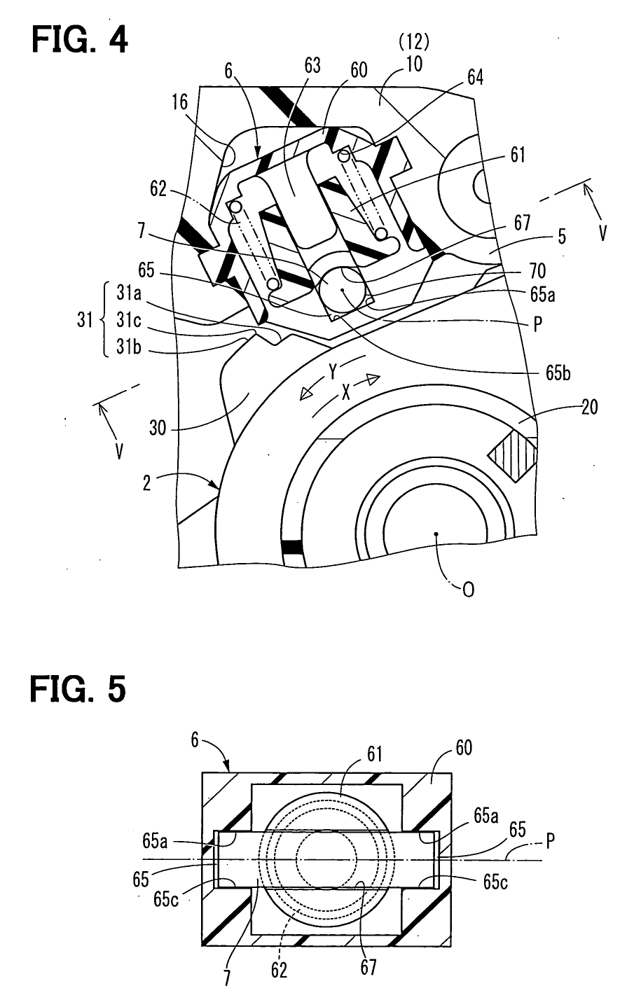

The arm 21 includes a cam 30 that uses the rotating shaft 20 as a cam shaft. The cam 30 is formed to have a projection that projects radially outwardly of the rotating shaft 20 from edges of the side walls 24, 25 opposed to the roof plate 12. As shown in FIGS. 2 and 4, the cam 30 defines a cam surface 31 on the projecting-side end surface thereof. A normal-rotation-direction forward portion 31a on the cam surface 31 is recessed radially inwardly of the rotating shaft 20 relative to a normal-rotation-direction rearward portion 31b. The cam surface 31 defines a cam mountain portion 31c at a corner that connects between the normal-rotation-direction forward portion 31a and the normal-rotation-direction rearward portion 31b. A profile curve defined by the cam mountain portion 31c in an axis-transverse cross section in FIG. 4 that is perpendicular to the rotating shaft 20 assumes a mountain-shape projecting toward an outer-peripheral side.

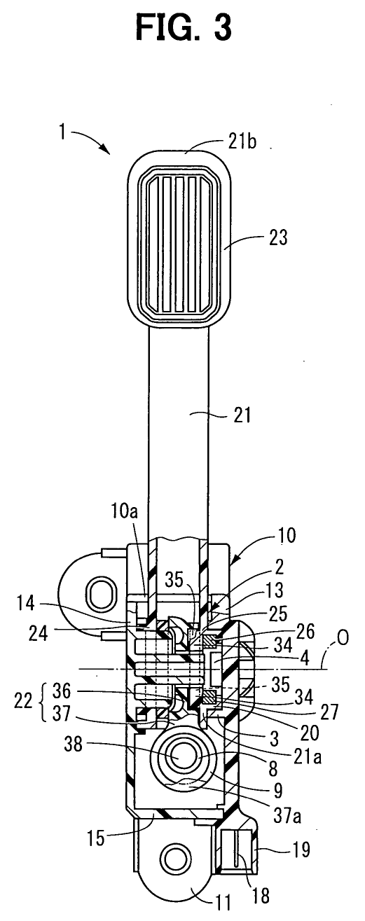

The rotor 22 formed from a resin material is received in the housing 10 as shown in FIGS. 2 and 3. The rotor 22 includes a disk-shaped turning portion 36, and both sides of the turning portion 36 are interposed between both the side walls 24, 25 of the arm 21. A plurality of helical gear teeth 35 are provided on a side of the turning portion 36 toward the side wall .25. The plurality of helical gear teeth 35 are arranged at equal intervals about the axis O. A plurality of helical gear teeth 34 are provided on a wall surface of the side wall 25 toward the turning portion 36. The plurality of helical gear teeth 34 are arranged at equal intervals about the axis O to mesh with one of the helical gear teeth 35 that are opposed to the former helical gear teeth in the axial direction. Such meshing makes the arm 21 and the rotor 22 integrally rotatable about the axis O. For example, when a driver treads on the tread portion 23 of the arm 21, the rotor 22 turns together with the arm 21 in the direction X of normal rotation.

The rotor 22 includes a plate-shaped engagement portion 37. The engagement portion 37 projects tangentially from an outer-peripheral edge of the turning portion 36. The engagement portion 37 has its both surfaces in a thicknesswise direction, facing the bottom plate 11 and the roof plate 12. A stepped columnar-shaped projection portion 38 projects from a surface of the engagement portion 37 toward the roof plate 12.

As described above, the end 21b of the arm 21 constitutes one end of the accelerator pedal 2, and a projecting-side end 37a of the engagement portion 37 on the rotor 22 constitutes the other end of the accelerator pedal 2, as shown in FIG. 2. The tread portion 23, the latch portion 28, the rotating shaft 20 as a cam shaft, and the engagement portion 37 are aligned in this order from the one end 21b to the other end 37 of the accelerator pedal 2.

Both springs 8, 9 as elastic members include compression coil springs. One spring 8 is smaller in coil diameter than the other spring 9, and is arranged in an inner-peripheral side of the other spring 9. One ends of the respective springs 8, 9 engage with the engagement hole 17 on the roof plate 12. The other ends of the respective springs 8, 9 engage with the projection portion 38 of the engagement portion 37. The respective springs 8, 9 are arranged in a manner to generate elastic reaction forces in the direction Y of reverse rotation, and exert the generated elastic reaction forces directly on the rotor 22 and indirectly on the arm 21. A resultant force Fe of such elastic reaction forces of the springs 8, 9 causes the accelerator pedal 2 to rotatably return in the direction Y of reverse rotation. The resultant force Fe of the elastic reaction forces is referred simply below to as elastic reaction force Fe.

The pedal stopper 5 projects toward the latch portion 28 of the arm 21 from an edge 50 of the roof plate 12 among the edges of the housing 10 that surround the opening 10a. A metallic insert nut 51 for reinforcement is embedded in the pedal stopper 5 that is formed by integral resin molding with the roof plate 12. A projecting-side end surface 52 of the pedal stopper 5 is formed to have a curved and convex surface. The projecting-side end surface 52 of the pedal stopper 5 is able to abut against the projecting-side end surface 29 of the latch portion 28. When the latch portion 28 separates from the pedal stopper 5, the accelerator pedal 2 is allowed to turn in both the direction X of normal rotation and the direction Y of reverse rotation. Meanwhile, while the latch portion 28 turns in the direction Y of reverse rotation to abut against the pedal stopper 5 to be latched thereon, turning of the accelerator pedal 2 stops.

The bias device 6 as bias means includes a casing 60, a holder 61, a spring 62, and the like as shown in FIGS. 2, 4, and 5. The casing 60 as a guide member is formed to have a bottomed rectangular cylinder, and is fitted into and fixed to the support hole 16 so that an opening of the case 60 faces toward the rotating shaft 20. The holder 61 is formed to be cylindrical-shaped, and arranged in the casing 60 with an opening thereof facing toward the rotating shaft 20. The holder 61 is fitted onto an outer-peripheral side of a projection 63 that projects from an inner wall at a bottom of the casing 60. The holder 61 is guided by the projection 63 to be able to reciprocate substantially along a diametrical axis of the rotating shaft 20. The spring 62 as a bias member includes a compression coil spring. One end of the spring 62 engages with a step 64 that is provided on an inner wall on the side of the casing 60. The other end of the spring 62 engages with an outer peripheral wall of the holder 61. The spring 62 is arranged in a manner to generate an elastic reaction force directed radially inwardly of the rotating shaft 20, that is, an elastic reaction force directed substantially toward the axis O of the rotating shaft 20, and the elastic reaction force as generated acts as a biasing force Fs on the holder 61. The biasing force Fs generated by the spring 62 is in proportion to a magnitude of compression of the spring 62 that varies according to a moved position of the holder 61.

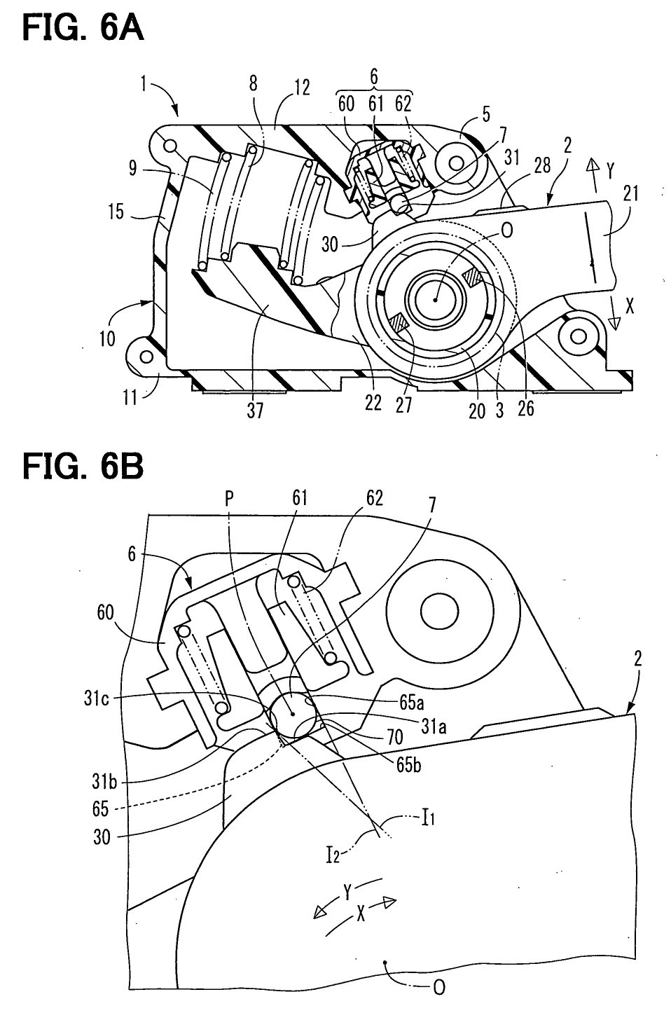

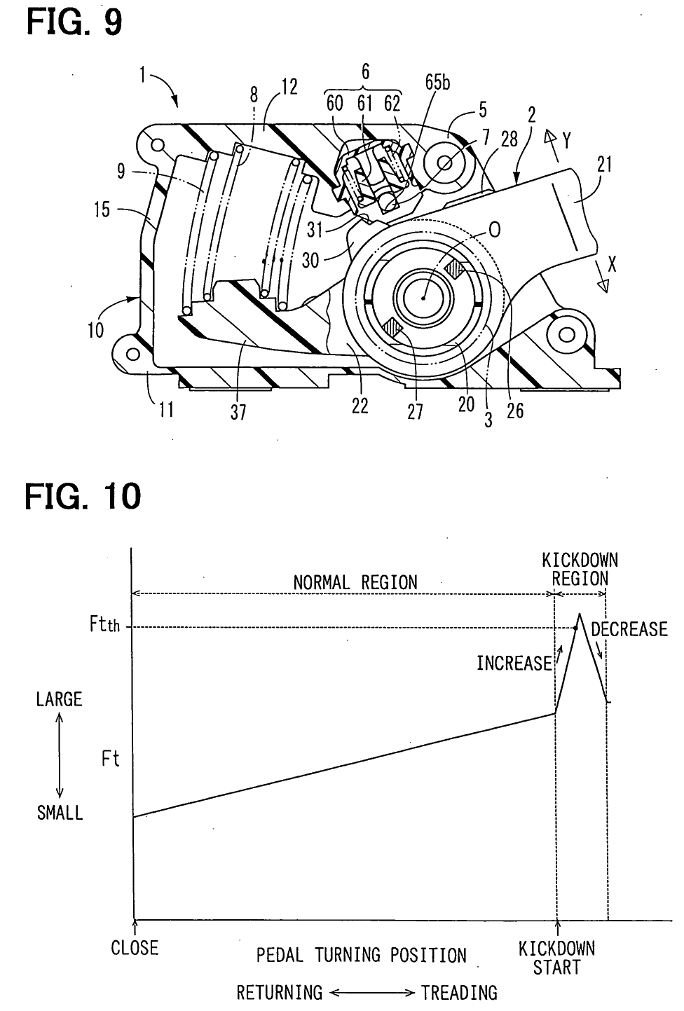

The follower roller 7 as a follower (driven body) is formed in a columnar shape, and its transverse cross section defines a circular outer peripheral surface 70. Both ends of the follower roller 7, respectively, are fitted into two guide grooves 65 provided on an inner wall on sides of the casing 60. Inner surfaces 65a directed in the direction Y of reverse rotation, among inner surfaces of the respective guide grooves 65 that extend substantially along the diametrical axis abut against the follower roller 7 from forward in the direction of normal rotation (normal rotation direction) to realize a wedge effect described later. The respective guide grooves 65 guide the follower roller 7 to enable the same to reciprocate substantially along the diametrical axis of the rotating shaft 20 while maintaining the axially parallel relationship with the rotating shaft 20. The follower roller 7 is further held by a holding groove 67 that is provided on an opening of the holder 61 facing toward the rotating shaft 20. The follower roller 7 is reversely rotatable about a center P of the outer peripheral surface 70 in a state, in which it is fitted into the respective guide grooves 65 and held by the holding groove 67. By the biasing force Fs of the spring 62, an inner surface of the holding groove 67 is pushed against the outer peripheral surface 70 of the follower roller 7, and thus the biasing force Fs of the spring 62 acts indirectly on the follower roller 7. Therefore, the follower roller 7 reciprocates together with the holder 61. When the cam 30 abuts against the follower roller 7 while rotating as shown in FIGS. 6A to 8B, the follower roller 7 is moved while being caused to abut against the cam surface 31. In contrast, when the cam 30 does not abut against the follower roller 7 as shown in FIGS. 2 and 9, the follower roller 7 abuts against inner surfaces 65b of the respective guide grooves 65 opposed to the rotating shaft and is engaged, so that radially inward movement of the follower roller 7 is restricted.

Subsequently, an operation of the accelerator device 1 will be described with reference to FIGS. 2 and 6A to 9. FIG. 2 shows a state in which a turning position (pedal turning position) of the accelerator pedal 2 corresponds to a fully closed position, FIG. 9 shows a state in which a pedal turning position is in a normal region, and FIGS. 6A to 8B show a state in which a pedal turning position is in a kickdown region that realizes kickdown.

When an action of the treading force Ft on the tread portion 23 is released, the latch portion 28 of the accelerator pedal 2 having been turned by the elastic reaction force Fe in the direction Y of reverse rotation is engaged by the pedal stopper 5, whereby the accelerator pedal 2 is stopped in the fully closed position shown in FIG. 2. At this time, the latch portion 28 is exerted by a resistance Fd that is directed in the direction X of normal rotation and opposed the elastic reaction force Fe, from the pedal stopper 5.

When a driver applies a treading force Ft on the tread portion 23 of the accelerator pedal 2 that is in the fully closed position, the accelerator pedal 2 is first turned in a normal region in the direction X of normal rotation as shown in FIG. 9. At this time, the cam 30 rotates without causing the cam mountain portion 31c to abut against the follower roller 7.

When the accelerator pedal 2 in the normal region is further turned by an increase in the treading force Ft in the direction X of normal rotation, a pedal turning position of the accelerator pedal 2 reaches a kickdown starting position shown in FIG. 6 to enter the kickdown region. Immediately before the pedal turning position reaches the kickdown starting position, the follower roller 7 engaged by the inner surfaces 65b of the respective guide grooves 65 enters in a portion of the normal-rotation-direction forward portion 31a, which is recessed on the cam surface 31, without substantial mutual interference.

When the pedal turning position of the accelerator pedal 2 is positioned in the kickdown starting position as shown in FIGS. 6A and 6B, the cam mountain portion 31c abuts, from rearward in the direction of normal rotation, against the outer peripheral surface (roller outer peripheral surface) 70 of the follower roller 7 entered in the normal-rotation-direction forward portion 31a of the cam surface 31. At this time, in an, axis-transverse cross section shown in FIGS. 6A and 6B, a tangent I₁ at a point, in which the cam mountain portion 31c and the roller outer peripheral surface 70 abut against each other, intersects a tangent I₂ at a point, in which the inner surfaces 65a of the respective guide grooves 65 directed in the direction Y of reverse rotation and the roller outer peripheral surface 70 abut against each other. Therefore, the biasing force Fs acts on the follower roller 7 toward an intersecting point of the tangents I₁ and I₂. Thus, the follower roller 7 is interposed between the cam mountain portion 31c and the inner surfaces 65a of the respective guide grooves 65, so as to be subjected to the wedge effect. When the treading force Ft increases in such state, a force Fw in proportion to the treading force Ft is exerted on the roller outer peripheral surface 70 by the cam mountain portion 31c whereby a pushing force Fp that pushes the follower roller 7 against the biasing force Fs increases. Hereupon, the accelerator device 1 is designed according to the embodiment such that when the treading force Ft exceeds a predetermined threshold Ftₜₕ shown in FIG. 10, the follower roller 7 begins to move radially outwardly of the rotating shaft 20 against the biasing force Fs.

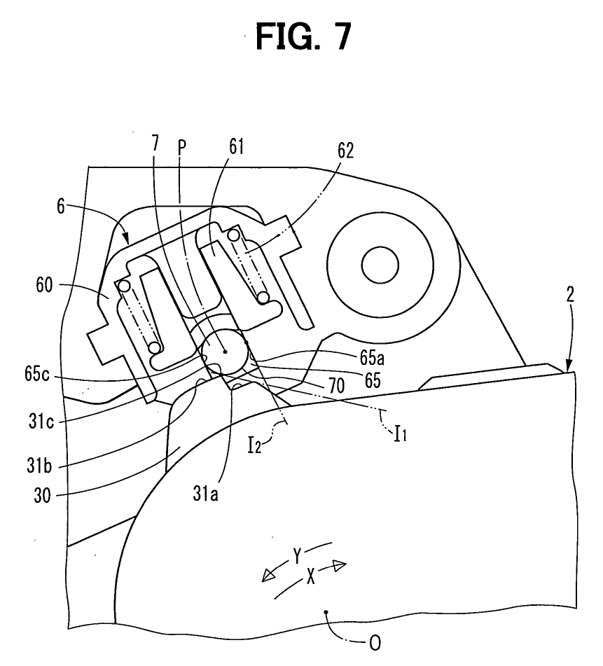

When the treading force Ft increases further after the follower roller 7 begins to move, the cam mountain portion 31c increases the force Fw acting on the follower roller 7 and hence the pushing force Fp on the follower roller 7 while coming into sliding contact with the roller outer peripheral surface 70 as shown in FIG. 7. At this time, since the tangents I₁ and I₂ continue to intersect each other, the wedge effect works and thus the follower roller 7 further moves against the biasing force Fs. Also, at this time, the follower roller 7 brings the roller outer peripheral surface 70 into sliding contact with the cam mountain portion 31c and the mutually facing the inner surfaces 65a, 65c of the respective guide grooves 65 while rotating about the center P. Further, at this time, the cam mountain portion 31c rotates in the direction X of normal rotation in a manner to slide the normal-rotation-direction rearward portion of the roller outer peripheral surface 70 of a circular cross section toward the axis O in the case where it is assumed that the follower roller 7 would not rotate.

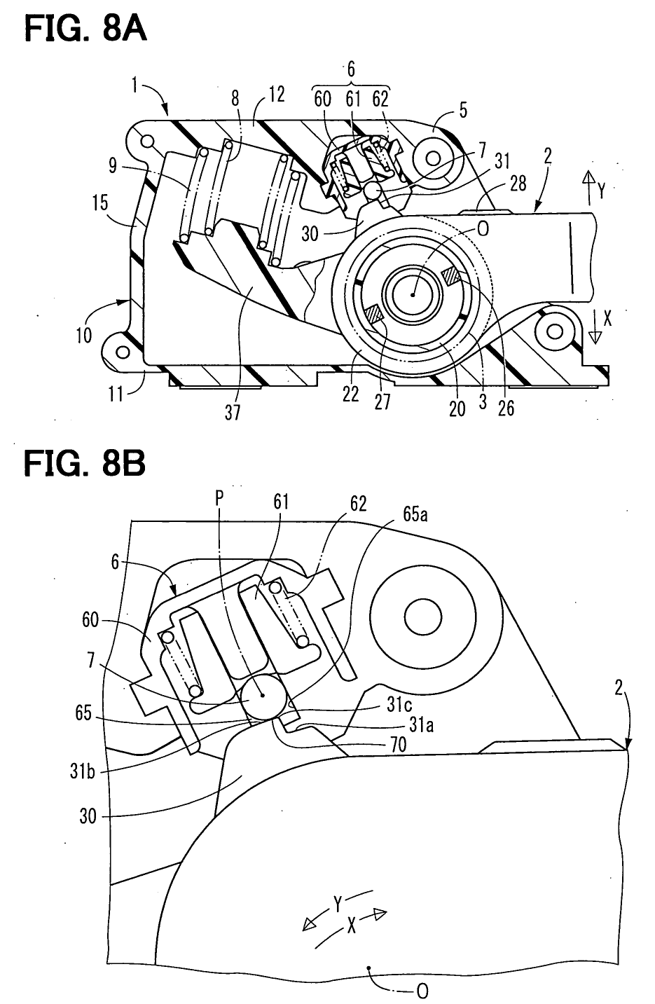

When the treading force Ft further increases after a point, in which the cam mountain portion 31c and the roller outer peripheral surface 70 abut against each other, has reached a point on the roller outer peripheral surface 70 closest to the axis O, the cam mountain portion 31c separates from the roller outer peripheral surface 70 as shown in FIG. 8, so that the normal-rotation-direction rearward portion 31b of the cam surface 31 abuts against the roller outer peripheral surface 70. Therefore, the follower roller 7 is not pressingly interposed between the cam surface 31 and the inner surfaces 65a of the respective guide grooves 65, so that the wedge effect does not exhibit. As a result, the treading force Ft required for rotating the cam 30 in the direction X of normal rotation is decreased as shown in FIG. 10. The accelerator device 1 is designed such that the biasing force Fs from the roller outer peripheral surface 70 acts on the normal-rotation-direction rearward portion 31b when the normal-rotation-direction rearward portion 31b of the cam surface 31 abuts against the roller outer peripheral surface 70,

The treading force Ft required for turning the accelerator pedal 2 in the direction X of normal rotation is reduced in the kickdown region by separation of the cam mountain portion 31c from the follower roller 7 after the cam mountain portion 31c abuts against the follower roller 7 to thereby increase the force. In this case, since increase and decrease in the required treading force Ft gives a driver a kickdown feeling like a click feeling, the driver can surely become aware of the fact that a pedal turning position gets into the kickdown region.

Since the follower roller 7 subjected to the wedge effect when the cam mountain portion 31c abuts against the follower roller 7 is pushed against the biasing force Fs, the accelerator device 1 enables rapidly increasing the treading force Ft required for such push in a short time. Besides, since the accelerator device 1 causes the cam mountain portion 31c to abut against the single follower roller 7 to increase the required treading force Ft, an increase in the required treading force Ft is precisely begun in the kickdown starting position. Thus a driver can correctly get aware of a moment when a pedal turning position reaches the kickdown region. That is, a driver can be given a kickdown feeling free from dispersion in a rise position.

Since the follower roller 7 is caused to come into sliding contact with the cam mountain portion 31c and the inner surfaces 65a, 65c of the respective guide grooves 65 while being rotated, the accelerator device 1 enables reducing sliding resistance in respective sliding locations. Accordingly, wear of the follower roller 7, the cam 30, and the casing 60 is suppressed, so that the accelerator device 1 is enhanced in durability.

In the accelerator device 1, since the holder 61 holds the follower roller 7 that is pushed by the cam mountain portion 31c against the biasing force Fs and the spring 62 engages with the holder 61, separation is hard to generate between the follower roller 7, the holder 61 and the spring 62. Accordingly, the biasing force Fs of the spring 62 can surely act on the follower roller 7.

In the accelerator device 1, the single follower roller 7 that is pushed by the cam 30 to be moved suffices to increase the required treading force Ft. Thus, miniaturization and reduction in cost can be achieved in contrast to an accelerator device in which two rollers are moved.

Subsequently, forces acting on the accelerator pedal 2 in the respective operating states described above will be described with reference to FIGS. 1 and 11 to 13. FIGS. 1 and 11 to 13 are schematic views showing forces acting on the accelerator pedal 2 when the accelerator pedal 2 is regarded as being a “lever” with the axis O as its fulcrum, by means of arrows in vector notation.

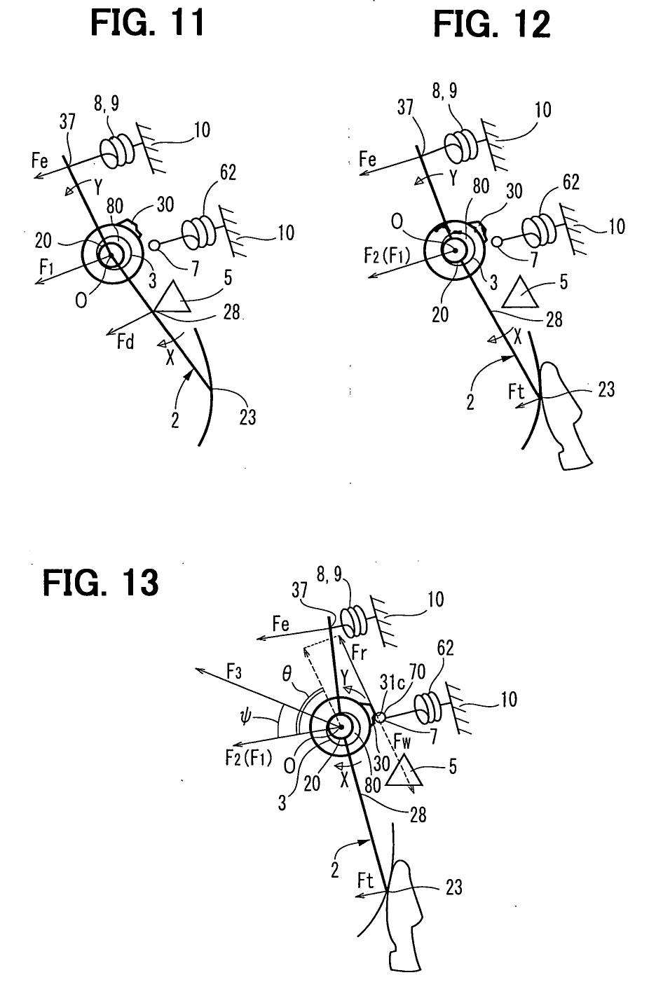

FIG. 11 shows a state, in which a pedal turning position corresponds to the fully closed position. In this state, the elastic reaction force Fe in the direction Y of reverse rotation and the resistance Fd directed in the direction X of normal rotation to oppose the elastic reaction force act on the engagement portion 37 and the latch portion 28, respectively, in a manner to meet balancing of moments about the axis O. As a result, the rotating shaft 20, on which a resultant force F₁ of the elastic reaction force Fe and the resistance Fd acts, is made offset in a direction of the resultant force F₁ due to a clearance 80 between it and the bearing portion 3.

FIG. 12 shows a state, in which a pedal turning position is in the normal region. In this state, the elastic reaction force Fe in the direction Y of reverse rotation and the treading force Ft in the direction X of normal rotation act on the engagement portion 37 and the tread portion 23, respectively, in a manner to meet balancing of moments about the axis O. As a result, a resultant force F₂ of the elastic reaction force Fe and the treading force Ft, which acts on the rotating shaft 20, is directed in substantially the same direction as that of the resultant force F₁ that acts on the rotating shaft 20 in the fully closed position. Accordingly, the rotating shaft 20 is made offset in substantially the same direction as that in the fully closed position.

FIG. 13 shows a state, in which a pedal turning position is in the kickdown region and the cam mountain portion 31c abuts against the roller outer peripheral surface 70. In this state, a reaction force Fr opposed to the force Fw acting on the roller outer peripheral surface 70 from the cam mountain portion 31c as well as the same forces Fe, Ft as those in the case where a pedal turning position is in the normal region acts on the accelerator pedal 2. The reaction force Fr is one that acts on the cam mountain portion 31c from the roller outer peripheral surface 70 in the direction Y of reverse rotation and meets balancing of moments about the axis O. In the embodiment, the accelerator device 1 is designed such that an angle formed between a vector representative of the reaction force Fr and a vector representative of the resultant force F₂ of the forces Fe, Ft constitutes an acute angle. Further, the accelerator device 1 is designed such that the resultant force F₂ in the kickdown region shown in FIG. 13 is directed in substantially the same direction as those of the resultant forces F₁, F₂ in the fully closed position and in the normal region. Owing to such design, a resultant force F₃ of the reaction force Fr and the resultant force F₂ acts on the rotating shaft 20 such that an angle ψ formed between a vector representative of the resultant force F₃ and vectors representative of the resultant forces F₁, F₂ in the fully closed position and in the normal region constitutes an acute angle. Accordingly, a direction, in which the rotating shaft 20 is made offset, is not reversed relative to a direction of offset in the fully closed position and in the normal region.

FIG. 1 shows a state, in which a pedal turning position is in the kickdown region and the normal-rotation-direction rearward portion 31b of the cam surface 31 abuts against the roller outer peripheral surface 70. In this state, the biasing force Fs directed substantially toward the axis O of the rotating shaft 20 as well as the same forces Fe, Ft as those in the case where a pedal turning position is in the normal region acts on the normal-rotation-direction rearward portion 31b of the cam surface 31 from the roller outer peripheral surface 70. In the embodiment, the accelerator device 1 is designed such that an angle ψ′ formed between a vector representative of the biasing force Fs directed substantially in a predetermined direction and a vector representative of the resultant force F₂ of the forces Fe, Ft constitutes an acute angle. Further, the accelerator device 1 is designed such that the resultant force F₂ in the kickdown region shown in FIG. 1 is directed in substantially the same direction as those of the resultant forces F₁, F₂ in the fully closed position and in the normal region. Owing to such design, a resultant force F₄ of the biasing force Fs and the resultant force F₂ acts on the rotating shaft 20 such that an angle ψ formed between a vector representative of the resultant force F₄ and vectors representative of the resultant forces F₁, F₂ in the fully closed position and in the normal region constitutes an acute angle. Accordingly, a direction, in which the rotating shaft 20 is made offset, is not reversed relative to a direction of offset in the fully closed position and in the normal region.

As described above, according to the embodiment, the reaction force Fr and the biasing force Fs, respectively, correspond to a first force, and the resultant forces F₁, F₂, respectively, correspond to a second force.

In the accelerator device 1 according to the first embodiment, a direction, in which the rotating shaft 20 is made offset relative to the bearing portion 3, can be made small in angular variation in an optional pedal turning position, so that output of the turning position sensor 4 exhibits linearity versus a tread stroke of the accelerator pedal 2. That is, it is possible to detect a turning position of the accelerator pedal 2 with high accuracy.

(Second to Fourth Embodiments)

In the second to fourth embodiments, a bias device 6 is different from the bias device 6 of the first embodiment. In the second to fourth embodiments, the other parts are substantially similar to those of the first embodiment.

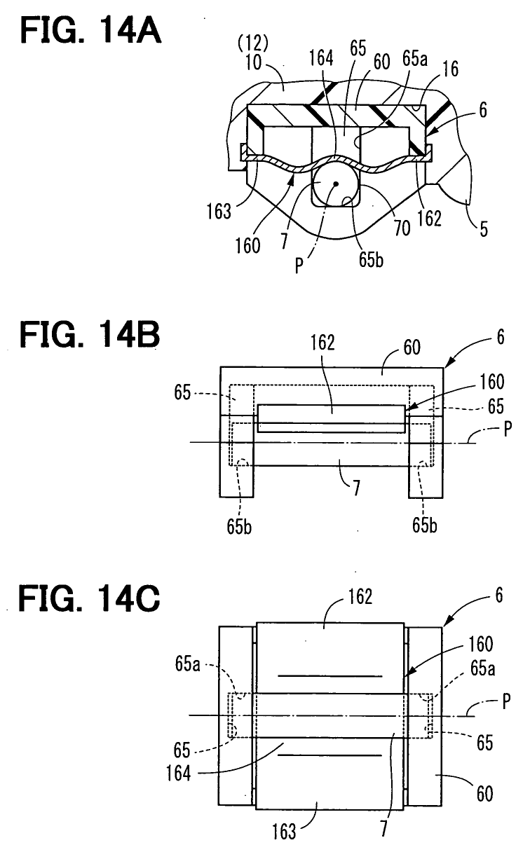

First, the second embodiment of the present invention will be now described with reference to FIGS. 14A-14C. In a bias device 6 according to the second embodiment, the holder 61 in the first embodiment is not provided and the follower roller 7 engages directly with a leaf spring 160 (plate spring) that replaces the spring 62 in the first embodiment. Specifically, the leaf spring 160 is in the form of a corrugate plate. Both ends 162, 163 of the leaf spring 160 in the direction of normal rotation are fixed to inner walls on sides of the casing 60 and supported on the housing 10 via the casing 60. A central portion of an intermediate part 164 of the leaf spring 160 that connects between the both ends 162, 163 is recessed radially outwardly of the rotating shaft 20. The recessed portion engages with the follower roller 7. In this state of engagement, the follower roller 7 is guided in the respective guide grooves 65 to be able to reciprocate substantially along the diametrical axis of the rotating shaft 20 and to reversely rotate about the center P of the roller outer peripheral surface 70. The leaf spring 160 generates an elastic reaction force directed substantially toward the axis O of the rotating shaft 20 and the generated elastic reaction force applies directly on the follower roller 7 as a biasing force Fs. The biasing force Fs generated by the leaf spring 160 is in proportion to deformation of the intermediate part 164 that varies according to a moved position of the follower roller 7.

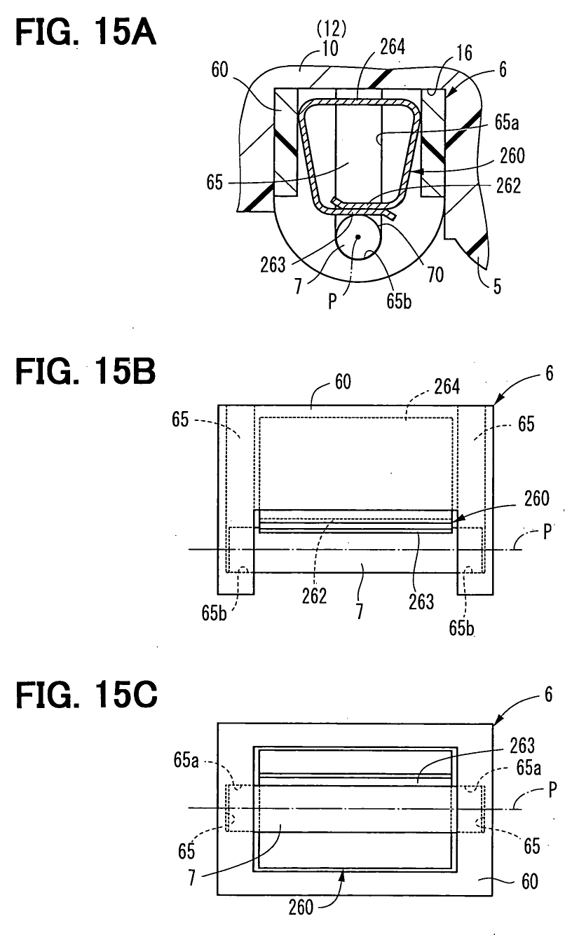

The third embodiment of the present invention will be now described with reference to FIGS. 15A-15C. In a bias device 6 according to the third embodiment, the holder 61 in the first embodiment is not provided and the follower roller 7 engages directly with a leaf spring 260 (plate spring) that replaces the spring 62 in the first embodiment. Specifically, the leaf spring 260 is in the form of a rectangular cylinder that is opened at both sides thereof along a direction toward the axis O and formed by overlapping both ends 262, 263 on one another. An intermediate part 264 of the leaf spring 260 that connects between the both ends 262, 263 is fixed at those portions thereof, which are opposed to the both ends 262, 263, to an inner wall of sides of the casing 60 and supported on the housing 10 via the casing 60. The both ends 262, 263 of the leaf spring 260 engage at outer peripheral sides thereof with the follower roller 7. In this state of engagement, the follower roller 7 is guided in the respective guide grooves 65 to be able to reciprocate substantially along the diametrical axis of the rotating shaft 20 and to reversely rotate about the center P of the roller outer peripheral surface 70. The leaf spring 260 generates an elastic reaction force directed substantially toward the axis O of the rotating shaft 20 and the generated elastic reaction force applies directly on the follower roller 7 as a biasing force FS. The biasing force Fs generated by the leaf spring 260 is in proportion to deformation of the both ends 262, 263 that varies according to a moved position of the follower roller 7.

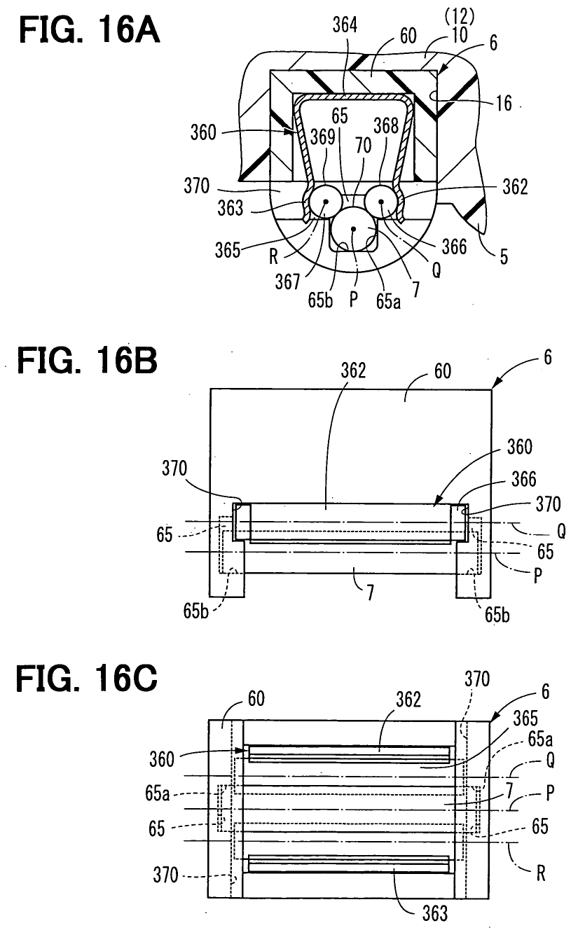

The fourth embodiment of the present invention will be now described with reference to FIGS. 16A-16C. In a bias device 6 according to the fourth embodiment, the holder 61 in the first embodiment is not provided and the follower roller 7 engages via two auxiliary rollers 366, 367 with a leaf spring 360 (plate spring) that replaces the spring 62 in the first embodiment. Specifically, the leaf spring 360 is formed to be U-shaped in cross section with both ends 362, 363 thereof opposed to each other. An intermediate part 364 of the leaf spring 360 that connects between the both ends 362, 363 is fixed at those portions thereof, which are opposed to an opening 365 that set apart the both ends 262, 263, to an inner wall on sides and a bottom of the casing 60 and supported on the housing 10 via the casing 60. Therefore, the opening 365 faces toward the rotating shaft 20 and the both ends 362, 363 extend with substantially the same spacing in a direction along the axis O.

Both the auxiliary rollers 366, 367 are formed to be columnar-shaped and define outer peripheral surfaces 368, 369 having a circular cross section. Both ends of the auxiliary rollers 366, 367 are fitted into two auxiliary guide grooves 370 provided on an inner wall on sides of the casing 60. The auxiliary rollers 366, 367 are guided in the respective auxiliary guide grooves 370 to be able to reciprocate in a direction substantially perpendicular to the diametrical axis of the rotating shaft 20 while being maintained in the parallel relationship with the rotating shaft 20. The both ends 362, 363 of the leaf spring 360 are recessed in opposition to the opening 365, and engage at the recessed portions with the auxiliary rollers 366, 367. The auxiliary rollers 366, 367 are made reversely rotatable about centers Q, R of outer peripheral surfaces 368, 369 in a state of being fitted into the respective auxiliary guide grooves 370 and engaged by the both ends 362, 363 of the leaf spring 360.

The auxiliary rollers 366, 367 have the respective outer peripheral surfaces 368, 369 abutting against the roller outer peripheral surface 70 at two circumferential locations from a side opposed to the rotating shaft to interpose the follower roller 7 therebetween. Therefore, the follower roller 7 engages via the auxiliary rollers 366, 367 with the both ends 362, 363 of the leaf spring 360 in a manner to be interposed therebetween. In this state of engagement, the follower roller 7 is guided in the respective guide grooves 65 to be able to reciprocate substantially along the diametrical axis of the rotating shaft 20 and to reversely rotate about the center P of the roller outer peripheral surface 70. As the follower roller 7 moves radially outwardly of the rotating shaft 20 from a state of abutting against inner surfaces 65b of the respective guide grooves 65, a spacing between the auxiliary rollers 366, 367 and hence a spacing between the both ends 362, 363 of the leaf spring is enlarged. At this time, the respective rollers 7, 366, 367 rotate about the centers P, Q, R, respectively, and come into sliding contact with one another, so that wear in locations of sliding contact is reduced.

The leaf spring 360 generates, at the both ends 362, 363 thereof, elastic reaction forces directed in two directions toward the opening 365 and the generated elastic reaction forces in the two directions apply on the auxiliary rollers 366, 367. The outer peripheral surfaces 368, 369 of the auxiliary rollers 366, 367 are pressed against the roller outer peripheral surface 70 by the elastic reaction forces applied from the leaf spring 360. Therefore, a resultant force of components obtained by decomposing the elastic reaction forces that act on the auxiliary rollers 366, 367 in the two directions, in directions from the centers Q, R to the center P acts on the follower roller 7 as a biasing force Fs that is directed radially inwardly of the rotating shaft 20. The biasing force Fs is in proportion to deformation of the both ends 362, 363 of the leaf spring that varies according to a moved position of the follower roller 7.

In the bias devices 6 according to the second, third and fourth embodiments, the biasing force Fs that presses the follower roller 7 against the cam surface 31 can be obtained with a simple construction and an effect similar to that in the first embodiment can be obtained. The bias device 6 can adopt a construction other than those in the first to fourth embodiments provided that such construction makes it possible to press the follower roller 7 against the cam surface 31.

Although the present invention has been fully described in connection with the preferred embodiments thereof with reference to the accompanying drawings, it is to be noted that various changes and modifications will become apparent to those skilled in the art.

For example, in the embodiments described above, the accelerator pedal 2 is composed of two members, that is, the arm 21 and the rotor 22 but the accelerator pedal can be composed of one or three or more members. The embodiments described above make use of the non-contact type turning position sensor 4 but it is possible to use a contact type turning position sensor that contacts with a rotating shaft of an accelerator pedal to detect a turning position of the rotating shaft.

In the embodiments described above, the tread portion 23, the latch portion 28, the rotating shaft 20, and the engagement portion 37 are provided in this order from one end side to the other end side of the accelerator pedal 2. Further, the elastic reaction forces Fe of the springs 8, 9 that are elastic members in the direction Y of reverse rotation, the resistance Fd of the pedal stopper 5 opposed to the elastic reaction forces Fe, and the treading force Ft in the direction X of normal rotation are applied onto corresponding positions of the accelerator pedal 2. In contrast, the tread portion 23, the rotating shaft 20, the latch portion 28, and the engagement portion 37 can be provided in this order from one end side to the other end side of the accelerator pedal 2. In this case, biasing forces of elastic members in a direction of reverse rotation, the resistance of a pedal stopper opposed to the biasing forces, and a treading force in a direction of normal rotation are applied onto corresponding portion of the accelerator pedal. By doing this, a direction, in which a cam shaft is made offset relative to a bearing portion, can be made small in angular variation in an optional pedal turning position, so that it is possible to enhance detection accuracy of a turning position sensor.

Such changes and modifications are to be understood as being within the scope of the present invention as defined by the appended claims.

What is claimed is:

1. An accelerator device comprising:
a housing having a bearing portion;
an accelerator pedal having a cam with a cam shaft that is supported by the bearing portion to be turned forward and reversely by an action of a treading force;
a follower that abuts against a cam surface of the cam when a turning position of the accelerator pedal is in a kickdown region;
a bias device that generates a biasing force to press the follower against the cam surface; and
a turning position sensor that detects a turning position of the accelerator pedal,
wherein the bias device is disposed such that the biasing force acts on the follower substantially toward a center of the cam shaft.

2. The accelerator device according to claim 1, wherein an angle between a vector representative of a first force and a vector representative of a second force is an acute angle, when the first force is defined by a force applied from the follower to the cam while the turning position of the accelerator pedal is in the kickdown region, and when the second force is defined by a force that acts on the accelerator pedal while the turning position of the accelerator pedal is in the kickdown region and is a resultant force of forces except the first force.

3. The accelerator device according to claim 1, wherein the cam shaft and the bearing portion are provided to have therebetween a clearance that allows a radial displacement of the cam shaft.

4. The accelerator device according to claim 1, wherein:
the cam surface has a cam mountain portion to define a mountain-shaped profile curve in an axis-transverse cross section that is perpendicular to the cam shaft; and
when the accelerator pedal turns in a normal rotation direction as the treading force increases, the cam mountain portion abuts against the follower from rearward in the normal rotation direction to push the follower against the biasing force and thereafter separates from the follower.

5. The accelerator device according to claim 4, further comprising a guide member that abuts against the follower from forward in the normal rotation direction to guide the follower in a predetermined direction, wherein:
in the axis-transverse cross section, a tangent at a point, in which the cam mountain portion and the follower abut against each other, and a tangent at a point, in which the guide member and the follower abut against each other, intersect each other, and the biasing force acts on the follower toward the point of intersection.

6. The accelerator device according to claim 5, wherein the follower having an outer peripheral surface that is circular in cross section brings the cam mountain portion and the guide member into sliding contact with the outer peripheral surface of the follower while rotating about a center of the outer peripheral surface of the follower.

7. The accelerator device according to claim 1, wherein the bias device includes a holder that holds the follower and reciprocates together with the follower, and a bias member that engages with the holder to generate the biasing force in accordance with a movement position of the holder.

8. The accelerator device according to claim 1, wherein the bias device includes a bias member that engages with the follower to generate the biasing force in accordance with a movement position of the follower.

9. The accelerator device according to claim 8, wherein:
the housing has a support member defining the bearing portion; and
the bias member is a spring that has two end portions supported by the support member, and an intermediate portion between the two end portions, engaged with the follower.

10. The accelerator device according to claim 8, wherein:
the housing has a support member defining the bearing portion;
the bias member is a spring that has two end portions overlapped with each other to have an overlapped portion, and an intermediate portion between the two end portions; and
the spring is supported by the support member at the intermediate portion, and is engaged with the follower at the overlapped portion.

11. The accelerator device according to claim 8, wherein:
the housing has a support member defining the bearing portion;
the bias member is a spring that has two end portions and an intermediate portion between the two end portions; and
the spring is supported at the intermediate portion by the support member, and engages with the follower to interpose the follower between the two end portions opposite to each other.

12. The accelerator device according to claim 2, further comprising
an elastic member and a pedal stopper, wherein:
the accelerator pedal includes a tread portion on which the biasing force in the normal rotation direction acts, an engagement portion that engages with the elastic member to be acted by an elastic reaction force from the elastic member in a reverse rotation direction, and a latch portion that is latched on the pedal stopper to be acted by a resistance that is directed in the normal rotation direction and opposed the elastic reaction force, from the pedal stopper;
the tread portion, the latch portion, the cam shaft, and the engagement portion are aligned in this order from one end of the accelerator pedal to the other end;
the second force is a resultant force of the treading force and the elastic reaction force when the treading force acts on the tread portion to turn the accelerator pedal; and
the second force is a resultant force of the elastic reaction force and the resistance when the treading force on the tread portion is released to have the latch portion latched on the pedal stopper to stop turning of the accelerator pedal.

13. The accelerator device according to claim 1, wherein the turning position sensor is disposed to detect a turning position of the cam shaft of the accelerator pedal.

14. An accelerator device comprising:
a housing having a bearing portion;
an accelerator pedal having a cam with a cam shaft that is supported by the bearing portion to be turned forward and reversely by an action of a treading force;
a follower that abuts against a cam surface of the cam when a turning position of the accelerator pedal is in a kickdown region;
a bias device that generates a biasing force to press the follower against the cam surface; and
a turning position sensor that detects a turning position of the accelerator pedal,
wherein an angle between a vector representative of a first force and a vector representative of a second force is an acute angle, when the first force is defined by a force applied from the follower to the cam while the turning position of the accelerator pedal is in the kickdown region, and when the second force is defined by a force that acts on the accelerator pedal while the turning position of the accelerator pedal is in the kickdown region and is a resultant force of forces except the first force.
